(19) United States
(12) Patent Application Publication
(10) Pub. No.: US 2026/0275558 A1
(43) Pub. Date: Sep. 17, 2026

(54) ELECTROCHEMICAL HYDROMETALLURGY FOR SUSTAINABLE IRONMAKING

(71) Applicant: The Johns Hopkins University, Baltimore, MD (US)

(72) Inventors: Hao SHEN, Baltimore, MD (US); Changao Zhou, Baltimore, MD (US); Yulin Liu, Baltimore, MD (US); Chao Wang, Ellicott City, MD (US)

(21) Appl. No.: 19/668,877

(22) Filed: May 6, 2026

Related U.S. Application Data
(63) Continuation-in-part of application No. PCT/US2024/054360, filed on Nov. 4, 2024.
(60) Provisional application No. 63/596,354, filed on Nov. 6, 2023.

(51) Int. Cl. C25C 1/06

(52) U.S. Cl. CPC C25C 1/06

(57) ABSTRACT

Disclosed herein is a system and method for ironmaking using a comproportionation system and an electrowinning system coupled with a direct air capture system comprising an electro-synthesizer system, a carbon dioxide capture system, and a carbonation system for sequestering carbon. The system and method enables the robust processing of various iron ores, while improving the energy efficiency of iron reduction, reducing environmental impact of mining and metallurgy, and mitigating emissions associated with the whole ironmaking process.

### CROSS-REFERENCE TO RELATED APPLICATIONS

This application is a continuation-in-part application claiming priority to International Patent Application No. PCT/US2024/054360 filed on 4 Nov. 2024, which claims the benefit of U.S. Provisional Application No. 63/596,354, filed Nov. 6, 2023, the contents of which are incorporated herein by reference in their entirety.

### GOVERNMENT SUPPORT CLAUSE

This invention was made with government support under grant DE-AR0001711 awarded by the Department of Energy. The government has certain rights in the invention.

### FIELD

The present disclosure relates to an electrochemical hydrometallurgical system, and method of using same, for efficient and more environmentally friendly ironmaking.

### BACKGROUND

Conventional iron making uses blast furnaces to reduce iron ore. Coke and CO are usually applied as reductants, leading to substantial quantities of emitted CO₂. In the prior art, electrochemical-based routes, for example using either molten salts or aqueous solutions, have been considered as a possible way to alleviate CO₂ emissions by using more sustainable electricity as the energy source and lowering the operating temperature. Molten oxide electrolysis could directly produce liquid iron from metal oxide ores, but disadvantageously it requires high temperatures (>1,000° C.) to maintain the electrolyte conductivity. For aqueous electrowinning, both alkaline and acid media have been studied. In the former, concentrated NaOH has been used as the electrolyte for electroreduction of hematite slurries, but the need for pure iron oxides and the use of highly corrosive reaction conditions (18 M of NaOH and >100° C.) makes this approach impractical for industrial implementation. While acid electrowinning can avoid these issues, the electrodeposition of Fe from dissolved cations is still challenged by the undesired side reactions of cathodic hydrogen evolution and anodic oxidation of migrated Fe²⁺.

Towards that end, the present invention relates to an improved system and method for ironmaking comprising an electrochemical hydrometallurgical system. Advantageously, the system can require only an iron-containing material feed and a gas source feed, not only removing carbon dioxide from the gas source but also producing an electrodeposited iron product that has greater than 99% purity.

### SUMMARY

In some aspects, a electrochemical hydrometallurgical for sustainable ironmaking (EHSI) system is described, said system comprising:
one or more flow electro-synthesizer systems configured to produce an acid solution and a hydroxide base solution;
one or more carbon dioxide capturing systems that is in fluid communication with the one or more flow electro-synthesizer systems and that are configured to capture a carbon dioxide from a gas source by converting the carbon dioxide to a carbonate-containing solution;
one or more acid leaching systems that are optionally in fluid communication with the one or more flow electro-synthesizer systems and that are configured to receive an iron-containing material comprising iron and produce a leachate comprising at least one of Fe³⁺ and Fe²⁺;
one or more comproportionation systems that are in fluid communication with the one or more acid leaching systems and that are configured to reduce Fe³⁺ in the leachate to Fe²⁺ and produce a Fe³⁺-free leachate;
one or more electrowinning systems that is in fluid communication with the one or more comproportionation systems and that are configured to convert the Fe²⁺ in the Fe³⁺-free leachate to Fe⁰; and
one or more carbonation systems that are in fluid communication with the one or more electrowinning systems and with the one or more carbon dioxide capturing systems and that are configured to sequester carbon from the carbonate-containing solution.

In some other aspects, a method of producing iron from an iron-containing material is described, said method comprising:
providing one or more of EHSI systems;
electrochemically generating a hydrogen gas and a hydroxide base on the cathode in the first compartment; and
flowing a stream comprising a generated hydrogen gas, a hydrogen gas provided by an external source, or a combination thereof, such that electrochemically generated hydrogen ions are formed on the anode to produce an acid solution;
directing at least a portion of the first electrolyte comprising the hydroxide base to one or more carbon dioxide capturing systems configured to capture a carbon dioxide from a gas source by converting the carbon dioxide to a carbonate-containing solution;
optionally directing at least a portion of the second electrolyte comprising acid solution to one or more acid leaching systems, wherein the one or more acid leaching systems comprise an iron-containing material, and a leachate comprising at least one of Fe³⁺ and Fe²⁺ is produced;
directing the leachate to the one or more comproportionation systems to reduce Fe³⁺ to Fe²⁺ to produce a Fe³⁺-free leachate;
directing the Fe³⁺-free leachate to the one or more electrowinning systems to produce Fe⁰, an acid solution, and iron-free solution;
optionally directing at least a portion of the acid solution from the one or more electrowinning systems to one or more acid leaching systems;
directing the carbonate-containing solution and the iron-free solution to the one or more carbonation systems to sequester the carbon from the carbonate-containing solution as a carbonate-containing solid, while generating a salt solution; and
directing the salt solution to the third compartment in the one or more flow electro-synthesizers to close the mass balance.
   In some embodiments, the one or more EHSI systems comprise:
one or more flow electro-synthesizer systems configured to produce an acid solution and a hydroxide base solution;
one or more carbon dioxide capturing systems that is in fluid communication with the one or more flow electro-synthesizer systems and that are configured to capture a carbon dioxide from a gas source by converting the carbon dioxide to a carbonate-containing solution;
one or more acid leaching systems that are optionally in fluid communication with the one or more flow electro-synthesizer systems and that are configured to receive an iron-containing material comprising iron and produce a leachate comprising at least one of Fe³⁺ and Fe²⁺;
one or more comproportionation systems that are in fluid communication with the one or more acid leaching systems and that are configured to reduce Fe³⁺ in the leachate to Fe²⁺ and produce a Fe³⁺-free leachate;
one or more electrowinning systems that is in fluid communication with the one or more comproportionation systems and that are configured to convert the Fe²⁺ in the Fe³⁺-free leachate to Fe⁰; and
one or more carbonation systems that are in fluid communication with the one or more electrowinning systems and with the one or more carbon dioxide capturing systems and that are configured to sequester carbon from the carbonate-containing solution.

Other aspects, features and advantages of the invention will be more fully apparent from the ensuing disclosure and appended claims.

### BRIEF DESCRIPTION OF THE FIGURES

FIG. 1. A schematic of the electrochemical hydrometallurgy for sustainable ironmaking (EHSI) system described herein.

FIG. 2. A schematic of multi-step leaching as described herein.

FIG. 3. Pourbaix diagram for iron.

FIG. 4A. Electrowinning of Fe from taconite mimic and serpentine leachate solutions. Photo of the flow electrochemical cell.

FIG. 4B. Cell performance of the flow electrochemical cell of FIG. 4A.

FIG. 4C. Cell performance of the flow electrochemical cell of FIG. 4A.

FIG. 4D. Photo of the electrowon Fe from taconite mimic and serpentine leachate solutions.

FIG. 4E. SEM image of the electrowon Fe product from taconite mimic and serpentine leachate solutions.

FIG. 4F. SEM image of the electrowon Fe product from taconite mimic and serpentine leachate solutions.

FIG. 4G. EDX element mapping analysis of the electrowon Fe product.

FIG. 4H. EDX element mapping analysis of the electrowon Fe product.

FIG. 5. Depicts an exemplary electro-synthesizer system in one embodiment.

### DETAILED DESCRIPTION OF THE DISCLOSURE

Although the claimed subject matter will be described in terms of certain embodiments, other embodiments, including embodiments that do not provide all of the benefits and features set forth herein, are within the scope of this disclosure as well. Various structural and parameter changes may be made without departing from the scope of this disclosure.

### Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents, and other references mentioned herein are incorporated by reference in their entirety. The materials, methods, and examples disclosed herein are illustrative only and not intended to be limiting.

“About” and “approximately” are used to provide flexibility to a numerical range endpoint by providing that a given value may be “slightly above” or “slightly below” the endpoint without affecting the desired result, for example, +/−5%.

The phrase “in one embodiment” or “in some embodiments” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

As used herein, a “system” refers to a plurality of real and/or abstract elements operating together for a common purpose. In some embodiments, a “system” is an integrated assemblage of hardware and/or software elements. In some embodiments, each component of the system interacts with one or more other elements and/or is related to one or more other elements. In some embodiments, a system refers to a combination of components and software for controlling and directing methods.

It will be understood that when an element is referred to as being “connected” or “coupled” or “being in fluid and/or electrical communication” to another element, it can be directly connected, coupled, or be on fluid and/or electrical communication to the other element, or intervening elements may be present. In contrast, when an element is referred to as being “directly connected,” “directly coupled,” or “in direct fluid and/or electrical communication” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, “carbon capture system” and “carbon dioxide contactor” are intended to be synonymous.

As used herein, “Fe³⁺-free leachate” corresponds to a leachate from the comproportionation/reduction system that is substantially free of Fe³⁺.

As used herein, the “aqueous iron-free solution” corresponds to a solution from the electrowinning system that is substantially free of any iron species.

As used herein, the term “recirculated-in-a-loop” defines a system where all streams of the system are recirculating within the loop. It is understood that substantially all streams disclosed herein are recirculated. However, in some examples, if needed, external streams are provided. Numerous general purpose or special purpose computing devices environments or configurations can be used with the systems and methods disclosed herein. Examples of well-known computing devices, environments, and/or configurations that can be suitable for use include but are not limited to, personal computers, server computers, handheld or laptop devices, smartphones, multiprocessor systems, microprocessor-based systems, network personal computers (PCs), minicomputers, mainframe computers, embedded systems, distributed computing environments that include any of the above systems or devices, and the like.

### The EHSI System

Broadly, the present invention relates to an electrochemical hydrometallurgy for sustainable ironmaking (EHSI) system. The EHSI system comprises leaching, comproportionation/reduction, electrowinning, acid-base electrosynthesis, carbon capture, and carbonation. The EHSI system will accomplish at least one of enabling the robust processing of various iron ores, improving the energy efficiency of iron reduction, reducing environmental impact of mining and metallurgy, and mitigating emissions associated with the whole manufacturing process. It thus represents a sustainable approach toward domestic production of iron and steel.

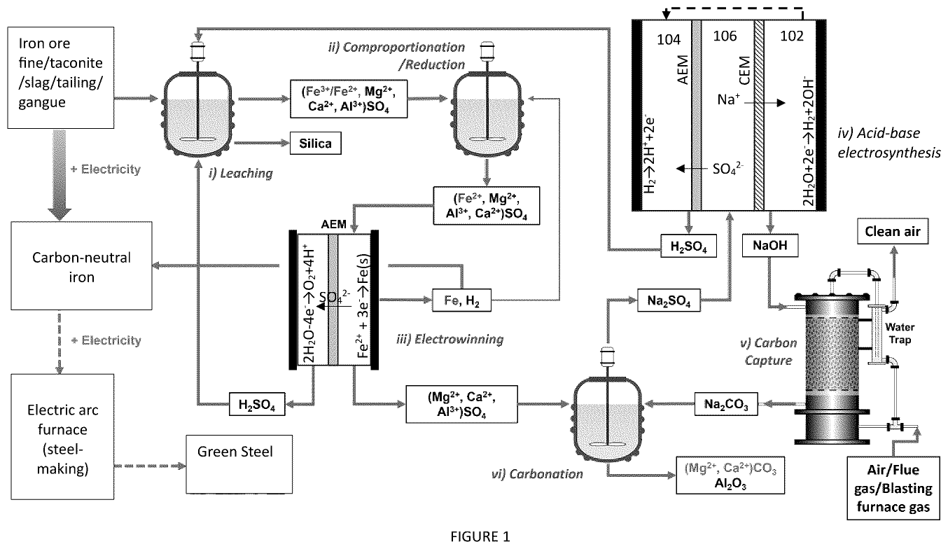

Referring to FIG. 1, the EHSI system comprises:
(i) one or more acid leaching systems, wherein acid solution(s) (e.g., H₂SO₄) remove silica and other precipitates from an iron-containing material to produce a leachate comprising at least one of Fe³⁺, Fe²⁺, Mg²⁺, Ca²⁺ and/or Al³⁺;
(ii) one or more acid comproportionation/reduction systems, wherein the leachate is subjected to treatment in the presence of a reducing agent to convert Fe³⁺ to Fe²⁺ to yield a Fe³⁺-free leachate comprising at least one of Fe³⁺, Mg²⁺, Ca²⁺ and/or Al³⁺.
(iii) one or more acid electrowinning systems, wherein a flowing anion-exchange membrane (AEM) electrolyzer is used for remove Fe from the Fe³⁺-free leachate to yield: Fe⁰; an aqueous iron-free solution comprising Mg²⁺, Ca²⁺ and/or Al³⁺; an acid solution (e.g., H₂SO₄); and H₂(g). Advantageously, the acid solution can be circulated back to the acid leaching system (i), a small portion (≤⅓) of the Fe⁰ product and the minor H₂ byproduct (<10% Faradaic efficiency, FE) from the cathode of the AEM electrolyzer can be used as the reducing agent in the comproportionation/reduction system (ii), and the aqueous iron-free solution can be fed to a carbon sequestration/carbonation system (vi);
(iv) one or more acid acid-base electro-synthesizer systems, wherein a salt solution (e.g., Na₂SO₄) from the carbonation device (vi) is split into an acid solution (e.g., H₂SO₄) and a hydroxide base (e.g., NaOH), with the former being recirculated for leaching in acid leaching system (i) and the latter for carbon capture from air in (v);
(v) one or more acid carbon capture systems which capture CO₂ from a gas source (e.g., air, flue gas, blasting furnace gas), which reacts with the hydroxide base from the acid-base electro-synthesizer (iv) to produce a carbonate-containing solution (e.g., Na₂CO₃) and CO₂-reduced gas or air; and
(vi) one or more acid carbon sequestration/carbonation systems wherein the carbon in the produced carbonate-containing solution is sequestrated as carbonate-containing solid (e.g., (Mg, Ca)CO₃) and the salt solution (e.g., Na₂SO₄) is generated and fed to the acid-base electro-synthesizer (iv) to close the mass balance.

The system, and process of using same, will enable robust processing of various iron-containing materials including, but not limited to, imported iron ore fines (e.g., magnetite, hematite, goethite, limonite, etc.), taconite, slag, tailing, gangue (e.g., serpentine) and mixtures thereof at various ratios. Oxides of Mg, Ca, Al, etc. present in the iron-containing materials can be accommodated in the leaching step (i) and utilized for carbon sequestration in the eventual carbonation step (vi). Advantageously, minor metals such as Co and Ni, for example from tailings and gangues in the feedstock, can also be extracted out, in addition to Fe⁰, during the electrowinning step and bring in additional value to the iron product for downstream steelmaking (e.g., ferronickel for stainless steel production).

It is understood that disclosed herein in FIG. 1, the lines are only exemplary and only shown to demonstrate communication between different system elements. It is understood that different types and numbers of lines can be used in each system as desired.

### Leaching System (i)

Acid leaching systems are known in the art. In some embodiments, the acid leaching system comprises at least one container comprising a single or multiple concentrations of acid solution. Iron-containing materials are introduced to the at least one container wherein the acid solution removes silica and other precipitates to produce a silica waste product and leachates comprising at least one of Fe³⁺, Fe²⁺, Mg²⁺, Ca²⁺ and/or Al³⁺. It is understood that all materials that are used to form the acid leaching system are chemically and physically compatible with the acid solution used in the system as well as output streams formed in the system. In some embodiments, if desired, the one or more acid leaching systems can comprise mixing means. In some embodiments, the leaching system comprises one container with a single concentration of acid solution. In some embodiments, the leaching system comprises more than one container, wherein each container has substantially the same concentration of acid solution (e.g., the leaching occurs in parallel). In some other embodiments, the leaching system comprises more than one container, wherein each container has a different concentration of acid solution (e.g., a multi-step leaching system, wherein the leaching process is in series).

In some embodiments, the iron-containing materials can be size-reduced and have an average size of about 5 mm to about 100 μm, including exemplary values of about 4 mm, about 3 mm, about 2 mm, about 1 mm, about 900 μm, about 800 μm, about 700 μm, about 600 μm, about 500 μm, about 400 μm, about 300 μm, about 200, and about 150 μm.

As shown in FIG. 1, the acid leaching system (i) is connected to the comproportionation/reduction system (ii), (optionally) the electrowinning system (iii), and (optionally) the acid-base electro-synthesis system (iv).

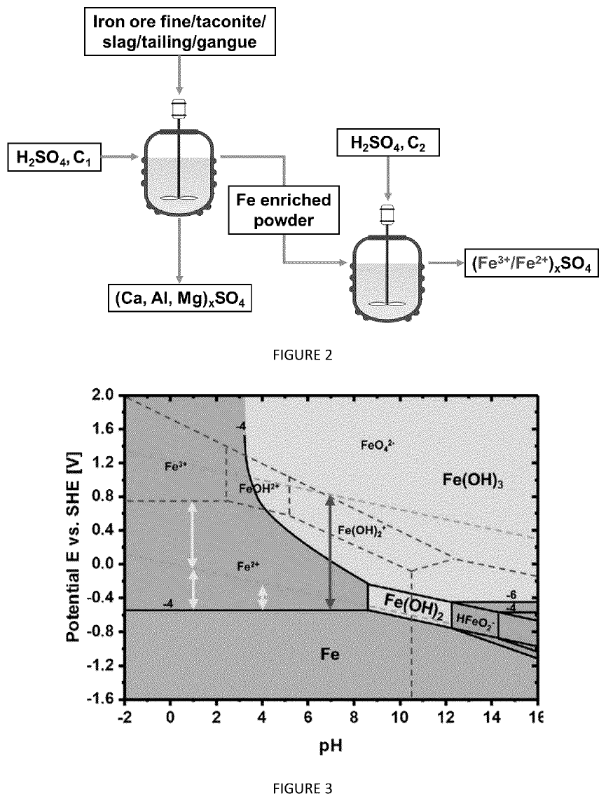

In some embodiments, to obtain a concentrated leachate, a multi-step leaching process with different concentrations of acid can be applied (FIG. 2). As shown in FIG. 2, the concentration of acid C₁ is not the same as the concentration of acid C₂. Each leachate comprises at least one of Fe³⁺, Fe²⁺, Mg²⁺, Ca²⁺ and/or Al³⁺. In some embodiments, the concentration of acid C₂ is greater than the concentration of acid C₁. When there are more than two containers in the multi-step leaching process, in some embodiments Cₙ>Cₙ₋₁> . . . >C₂>C₁, while in some other embodiments Cₙ=Cₙ₋₁= . . . =C₂>C₁, while in some other embodiments Cₙ=Cₙ₋₁= . . . =C₃>C₂>C₁.

As will be described, a source for the acid solution can be the acid-base electro-synthesizer system (iv), the electrowinning system (iii), or both the acid-base electro-synthesizer system (iv) and the electrowinning system (iii), via the respective connections. It should be appreciated by the person skilled in the art that a source of all, or a portion, of the acid solution can be from an external source instead.

### Comproportionation Reduction System (ii)

It is known that the direct electrodeposition of Fe⁰ from Fe³⁺ solutions is complicated by the fact that Fe³⁺ is only stable at relatively low pH values, as shown in the Fe Pourbaix diagram (FIG. 3). Accordingly, the presence of Fe³⁺ in an electrowinning solution is highly undesirable because it lowers the cathode efficiency for depositing the metal and it may cause deposits to be brittle, stressed, and pitted. To circumvent this problem, a comproportionation/reduction step (ii), which converts Fe³⁺ to Fe²⁺, was integrated into the EHSI system prior to electrowinning (iii), to yield a Fe³⁺-free leachate. In some embodiments, the reducing agent comprises at least one of Fe⁰ and hydrogen gas. It is understood that all materials that are used to form the comproportionation/reduction system are chemically and physically compatible with the leachate and reducing agent(s) used in the system as well as output streams formed in the system. In some embodiments, if desired, the one or more comproportionation/reduction systems can comprise mixing means.

In some embodiments, as will be described hereinbelow, the source of the Fe⁰ reducing agent can be the electrowinning system (iii). It should be appreciated by the person skilled in the art that a source of all, or a portion, of the Fe⁰ reducing agent can be from an external source instead.

As shown in FIG. 1, the comproportionation/reduction system (ii) is connected to the acid leaching system (i) and the electrowinning system (iii).

Although the EHSI system described herein does include a comproportionation/reduction step, it should however be appreciated that in some embodiments, a EHSI system can be designed that does not include a comproportionation/reduction step (ii), instead directly electrowinning Fe⁰ from the leachate, as understood by the person skilled in the art.

Electrowinning System (iii)

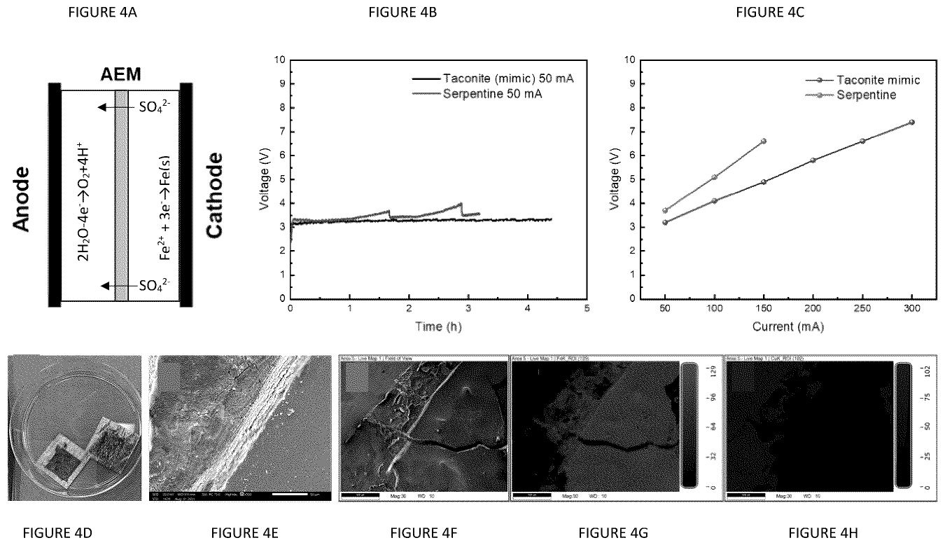

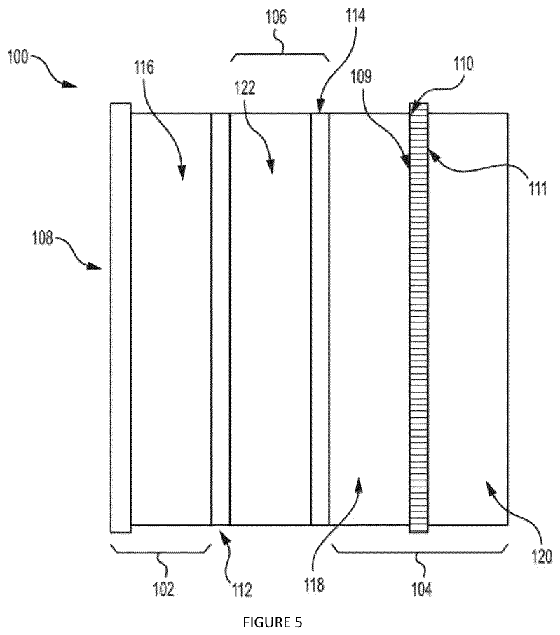

The incorporation of comproportionation/reduction step (ii) in the EHSI system facilitates the electrowinning (iii) of Fe⁰ from the Fe³⁺-free leachate, which minimizes the overpotential and reduces parasitic hydrogen evolution, while the separation of the cathode and anode with AEM eliminates the reoxidation of Fe²⁺ during electrowinning. Advantageously, this electrowinning (iii) technology can achieve >50% energy efficiency, representing a significant enhancement versus conventional high-temperature thermochemical processing (e.g., ~10% energy efficiency for blasting furnace, BF). The flowing AEM electrolyzer also minimizes the discharge of hazardous chemical waste because the mass balance of involved chemicals (e.g., acid solution, hydroxide base, salt solution) is closed. In some embodiments, the flowing AEM electrolyzer has the structure shown in FIG. 4A. The electrode reactions in the AEM shown in FIG. 4A can be written as:

Cathode: Fe²⁺(aq.)+2e⁻→Fe(s); E⁰=−0.44 V vs. SHE (2)

Anode: 2H₂O→O₂+4H⁺+4e⁻; E=1.23 V vs. RHE (3)

Note that the potential of reaction (2) is pH independent, whereas reaction (3) is not. This feature gives a pH-dependent voltage for the full-cell reaction (when the anion is sulfate):

Full-cell: 2FeSO₄+2H₂O→2Fe+2H₂SO₄+O₂; ΔE⁰=1.57 V-0.059*pH (4)

During the electrowinning process, sulfate anions migrate across the anion-exchange membrane (AEM), recombine with the protons released from the oxygen evolution reaction on the anode and thus generate acid solution (e.g., H₂SO₄), which can be used ore leaching in step (i). The anode of the flowing AEM electrolyzer can be at least one of DSA, IrO₂/RuO₂ or Pt. The cathode flowing AEM electrolyzer can be at least one of C, Fe, Cu, Ni, Ti, lead alloy, or any combination thereof. Referring to FIGS. 4B and 4C, at a current density of 50 mA/cm², cell voltages of 3.1 and 3.5 V for taconite (~1.3 M of Fe²⁺) and serpentine (~0.37 M of Fe²⁺) leachates (after comproportionation) were recorded, respectively. In both cases, >90% FE was achieved toward Fe electrodeposition and smooth Fe films that are densely packed and free of dendrites were obtained at >99% purities (see, FIGS. 4F-4H).

In some embodiments, the purity of the iron electrodeposited in the electrowinning system is greater than about 90%, or greater than about 95%, or greater than about 96%, or greater than about 97%, or greater than about 98%, or greater than about 99%.

Advantageously, at least a portion of the Fe⁰ derived from electrowinning (iii) can be used to reduce Fe³⁺ in the comproportionation/reduction process (ii) according to:

2Fe³⁺+Fe →3Fe²⁺ (1)

Furthermore, the comproportionation/reduction process (ii) step can also leverage the H₂ byproduct from the electrowinning step (iii) as a reductant. From FIG. 3 it can be seen that now the electrowinning can be operated at relatively high pH to lower the overpotential for hydrogen evolution, e.g., <0.3 V at pH >4. It should be appreciated that some, or all, of the Fe⁰ from the electrowinning system, referred to herein as “carbon neutral iron,” can be used for steelmaking, as shown in FIG. 1.

It is understood that all materials that are used to form the electrowinning system are chemically and physically compatible with the Fe³⁺-free leachate used in the system as well as output streams formed in the system. In some embodiments, if desired, the one or more electrowinning systems can comprise mixing means.

As shown in FIG. 1, the electrowinning system (iii) is connected to the acid leaching system (i), comproportionation/reduction system (ii), and the carbonation system (vi). It should be appreciated that the acid solution produced in the electrowinning system (iii) does not have to be delivered to the acid leaching system and instead can be sold as a commodity. As such, in some embodiments, the electrowinning system (iii) is connected only to the comproportionation/reduction system (ii) and the carbonation system (vi) (not shown).

Direct Air Capture (iv)-(vi)

It is known that electrowinning consumes electricity to reduce Fe²⁺ to Fe⁰, which has a carbon footprint (approximately 387 g-CO2e/kWh in 2023). To mitigate this and other emissions associated with ironmaking, a direct air capture (DAC) process (comprising the acid-base electro-synthesizer (iv), the carbon capture system (v), and the carbonation system (vi)) is included in the EHSI system. In the electro-synthesizer (iv), for energy-efficient synthesis of acid solution and hydroxide base, the chemical reaction when the salt solution comprises sodium sulfate is:

Na₂SO₄+2H₂O→H₂SO₄+2NaOH (5)

A three-compartment cell coupled with a hydrogen gas loop, as described at length below, allows for the operation of reaction (5) at merely ~1.5 V. The electrosynthesized hydroxide base from (iv) is then used to capture CO₂ from air in the carbon capture system (v) using an air contactor according to:

2NaOH+CO₂→Na₂CO₃+H₂O (6)

and the acid solution from the electro-synthesizer (iv) can be circulated back to acid leaching (i). A carbonate-containing solution produced in reaction (6) is further combined with the iron-free solution from electrowinning (iii) according to:

(Mg,Ca)SO₄+Na₂CO₃→Na₂SO₄+(Mg,Ca)CO₃ (7)

As a result, carbon is sequestered as solid carbonates, which can be readily disposed of, e.g., deposited back in abandoned mining wells. No additional CO₂ sequestration is needed.

In an exemplary and unlimiting aspect, the electro-synthesizer system comprises the system described in co-pending U.S. patent application Ser. No. 18/360,326, filed on Jul. 27, 2023, in the name of Chao Wang et al. and entitled “Electrolyzers,” and in co-pending International Patent Application PCT/US2023/071105, filed on Jul. 27, 2023, in the name of Chao Wang et al. and entitled “Electrolyzers and Use of the Same for Carbon Dioxide Capture and Mining,” which are hereby incorporated by reference herein in their entirety.

Disclosed herein are embodiments directed to an electro-synthesizer system introduced in FIG. 1 but shown in more detail in FIG. 5. In certain embodiments, the electro-synthesizer system is a flow unit. In further embodiments, the electro-synthesizer system comprises a number of compartments. FIG. 5 shows an exemplary electro-synthesizer system 100 comprising a first compartment 102, a second compartment 104, and a third compartment 106.

The first compartment 102 can comprise a cathode 108 and a first inlet (not shown) configured to receive a first flow of a first electrolyte solution. The first compartment further comprises the first electrolyte solution 116, which is in electrical and fluid communication with the cathode 108. In such exemplary and unlimiting embodiments, a pH of the first electrolyte solution 116 can be about 6≤pH≤15.5, including exemplary values of about 6, about 6.5, about 7, about 7.5, about 8, about 8.5, about 9, about 9.5, about 10, about 10.5, about 11, about 11.5, about 12, about 12.5, about 13, about 13.5, about 14, about 14.5, about 15, and about 15.5. It is understood that at any point, the first compartment can comprise the first electrolyte having a pH value that falls within any two foregoing values. In yet still further embodiments, the pH of the first electrolyte can change during the system operation. While in yet still further embodiments, the pH of the first electrolyte is kept substantially the same during the system operation, depending on the desired outcome. In still further embodiments, the cathode is configured to generate a hydrogen gas and a hydroxide. The first compartment further comprises one or more outlets (not shown) configured to remove the generated hydrogen gas and/or a hydroxide base generated in the first compartment.

In some embodiments, the first electrolyte comprises the hydroxide base. In some embodiments, the first electrolyte is the hydroxide base. Any known in the art bases can be used including, but not limited to, sodium hydroxide, lithium hydroxide, potassium hydroxide, magnesium hydroxide, calcium hydroxide, ammonium hydroxide, amine-based bases, sodium acetate, or any combination thereof. In still further embodiments, the bases can comprise amine-based bases, such as primary, secondary, tertiary amines, or any combination thereof It is understood that other organic bases can be utilized. In some embodiments, the first electrolyte comprises sodium hydroxide. In still further embodiments, the base can be strong or weak, depending on the desired pH, as commonly defined in chemical arts. In yet still further embodiments, the bases can also comprise Lewis bases. It is understood that the base can be present in any concentration to provide the desired pH. The concentration can be measured in M, or it can be measured in wt %, depending on the desired application. In still further embodiments, the base can be present in any concentration from 0 M to about 20 M, including exemplary values about 0.001 M, about 0.005 M, about 0.01 M, about 0.05 M, about 0.1 M, about 0.5 M, about 1 M, about 2 M, about 3 M, about 4 M, about 5 M, about 6 M, about 7 M, about 8 M, about 9 M, about 10 M, about 11 M, about 12 M, about 13 M, about 14 M, about 15 M, about 16 M, about 17 M, about 18 M, and about 19 M. It is understood that these values are only exemplary, and the base can be present in a concentration having any values between any two foregoing values.

In still further embodiments, the first electrolyte comprises one or more inorganic salts. In some exemplary and unlimiting embodiments, the first electrolyte can comprise a salt without the presence of the base. Yet, in other embodiments, the first electrolyte can comprise only a hydroxide base. In yet still further embodiments, the first electrolyte can comprise the salt and the hydroxide base in any desired concentration. It is understood that the salt is present in the first electrolyte can be at any concentration before its saturation. In certain embodiments, the salt and the hydroxide base present in the electrolyte can have the same cation or a different cation. In yet other embodiments, the combination of various salts (having the same cations but different anions or the same anions but different cations) can be present. Yet, in still further embodiments, the combination of the various bases can also be present in the first electrolyte. In still further embodiments, the one or more inorganic salt can comprise chlorides, sulfates, nitrates, phosphates, citrates, formates, lactates, tartrates, malates, fumarates, oxalates, succinates, gluconates, ascorbates, acetates of alkaline metals and/or alkaline-earth metals, or mixtures thereof.

The second compartment 104 comprises an anode 110. The anode 110 has a first surface 109 and a second surface 111. In still further embodiments, the second compartment 104 comprises a second inlet (not shown) configured to receive a second flow of a second electrolyte solution 118 and a third inlet (not shown) configured to receive a stream 120 comprising a hydrogen gas. In still further embodiments, the second inlet of the second compartment extends into a first channel, and the third inlet extends into a second channel. In such embodiments, the first channel is positioned between an anion exchange membrane (AEM) 114 and the first surface 109 of the anode 110 and hosts the second electrolyte 118. While in other embodiments, the second channel is positioned abut the second surface 111 of the anode 110 and is configured to receive the hydrogen gas stream 120.

In certain embodiments, the hydrogen gas stream 120 can comprise the hydrogen gas generated in the first compartment 102. In such embodiments, the generated hydrogen gas is directly fed from the first compartment to the second compartment, forming the looping of the hydrogen gas between the first and the second compartment of the system. However, also disclosed herein are embodiments wherein the hydrogen gas stream 120 comprises a hydrogen gas supplied from any external source, such as a hydrogen tank, externally generated hydrogen, and the like. In yet still further embodiments, the hydrogen gas stream 120 can comprise both the hydrogen generated in the first compartment and the hydrogen gas received from the external source. In still further embodiments, disclosed are implementations where an operator can switch the supply of the hydrogen gas stream 120 as desired.

In still further embodiments, the second electrolyte comprises an acid solution. In some embodiments, the second electrolyte is the acid solution. Any known in the art acids can be used. For example, the acid solution can comprise one or more of hydrochloric acid, hydrobromic acid, hydroiodic acid, sulfurous acid, sulfuric acid, nitric acid, phosphorous acid, phosphoric acid, hypochlorous acid, chlorous acid, chloric acid, perchloric acid, formic acid, acetic acid, carbonic acid, or any combination thereof. In still further embodiments, the acids can comprise organic acids. In some embodiments, the second electrolyte comprises sulfuric acid. In some embodiments, the second electrolyte comprises hydrochloric acid. In still further embodiments, the acid can be strong or weak, depending on the desired pH, as commonly defined in chemical arts. In yet still further embodiments, the acid can also comprise Lewis acids. It is understood that the acid can be present in any concentration to provide for the desired pH. The concentration can be measured in M, or it can be measured in wt %, depending on the desired application. In still further embodiments, the acid can be present in any concentration from 0 M to about 10 M, including exemplary values about 0.001 M, about 0.005 M, about 0.01 M, about 0.05 M, about 0.1 M, about 0.5 M, about 1 M, about 2 M, about 3 M, about 4 M, about 5 M, about 6 M, about 7 M, about 8 M, and about 9 M. It is understood that these values are only exemplary, and the acid can be present in the acid solution at a concentration having any values between any two foregoing values.

In still further embodiments, the second electrolyte comprises one or more inorganic salts. In some exemplary and unlimiting embodiments, the second electrolyte can comprise a salt without the presence of the acid. Yet, in other embodiments, the second electrolyte can comprise only an acid. In yet still further embodiments, the second electrolyte can comprise the salt and the acid solution in any desired concentration. It is understood that the salt present in the second electrolyte can be at any concentration before its saturation. In certain embodiments, the salt and the acid present in the electrolyte can have the same cation or a different cation. In yet other embodiments, the combination of various salts (having the same cations but different anions or the same anions but different cations) can be present. Yet in still further embodiments, the combination of the various acids can also be present in the second electrolyte. In still further embodiments, the one or more inorganic salt can comprise chlorides, sulfates, nitrates, phosphates, citrates, formates, lactates, tartrates, malates, fumarates, oxalates, succinates, gluconates, ascorbates, acetates of alkaline metals and/or alkaline-earth metals, or mixtures thereof.

It is understood that using hydrogen to generate hydrogen ions (either by looping the hydrogen from the first compartment to the second compartment or using both streams of hydrogen) improves the overall efficiency of the process. The hydrogen-depolarized reaction reduces both the energy cost and the electrode polarization in this electrolysis process. For example, in embodiments where the pH gradient between the compartments is extreme (for example, pH=14 in the first compartment and pH=0 in the second compartment), the hydrogen-induced loop will only cost 0.83 V for the pH gradient, which is 60% more efficient than the typical salt splitting process. The half-reactions and their standard potential of anode (8) and cathode (7) are,

At pH=14, 2 H₂O−2e⁻→H₂+2 OH⁻ φ=−0.83 V vs. SHE (7)

At pH=0, H₂+2e⁻→2H⁺φ=0 V vs. SHE (8)

In one embodiment, the second electrolyte solution 118 is in electrical and fluid communication with the anode. For example, the second electrolyte solution 118 is in electrical and fluid communication with the first surface 109 of the anode 110. In still further embodiments, a pH of the second electrolyte solution is about −1.5≤pH≤8, including exemplary values of about −1.5, about −1, about −0.5, 0, about 0.5, about 1, about 1.5, about 2, about 2.5, about 3, about 3.5, about 4, about 4.5, about 5, about 5.5, about 6, about 6.5, about 7, about 7.5, and about 8. It is understood that at any point of, the second compartment can comprise the second electrolyte having a pH value that falls within any two foregoing values. In yet still further embodiments, the pH of the second electrolyte can change during the system operation. While in yet still further embodiments, the pH of the second electrolyte is kept substantially the same during the system operation, depending on the desired outcome. In still further embodiments, the anode is configured to oxidate the hydrogen gas to generate hydrogen ions. In yet still further embodiments, the second compartment comprises an outlet (not shown) configured to remove an acid solution comprising the generated hydrogen ions from the second compartment.

The system 100 further comprises a third compartment 106 positioned between and in fluid communication with the first compartment 102 and the second compartment 104, wherein the third compartment 106 is separated from the first compartment 102 with one or more cation exchange membranes (CEM) 112 and is separated from the second compartment 104 with one or more anion exchange membranes (AEM) 114.

In still further embodiments, the third compartment 106 comprises a fourth inlet (not shown) configured to receive a third flow of a third electrolyte solution 122, which can comprise some, or all, of the salt solution from the carbonation system (vi). In such embodiments, the third electrolyte solution 122, can have a pH of about 4≤pH≤10, including exemplary values of about 4, about 4.5, about 5, about 5.5, about 6, about 6.5, about 7, about 7.5, about 8, about 8.5, about 9, about 9.5, and about 10. It is understood that at any point of, the third compartment can comprise the third electrolyte having a pH value that falls within any two foregoing values. In yet still further embodiments, the pH of the third electrolyte can change during the system operation. While in yet still further embodiments, the pH of the third electrolyte is kept substantially the same during the system operation, depending on the desired outcome. In still further embodiments, the third compartment also can comprise an outlet configured (not shown) to remove the third electrolyte from the third compartment. In still further embodiments, the third electrolyte solution can comprise one or more inorganic salts. In still further embodiments, the one or more inorganic salt comprises chlorides, sulfates, nitrates, phosphates, citrates, formates, lactates, tartrates, malates, fumarates, oxalates, succinates, gluconates, ascorbates, acetates of alkaline metals and/or alkaline-earth metals, or mixtures thereof. In yet still further embodiments, the one or more inorganic salts in the third electrolyte can be referred to as brine. In some embodiments, the third electrolyte comprises salt solution (e.g., sodium sulfate) from the carbonation system (vi). In some embodiments, the third electrolyte comprises salt solution (e.g., sodium chloride) from the carbonation system (vi).

In still further embodiments, while the disclosed above inlets and outlets are not shown in FIG. 5, the skilled practitioner can understand that inlet and outlet can be positioned anywhere within the compartment to allow inflow and outflow of respective streams as described. For example, each of the compartments can have one or more inlets and/or one or more outlets. In some embodiments, the generated in the first compartment hydrogen gas and the base solution comprising the generated hydroxide base can be removed from the same outlet. Yet in other embodiments, the first compartment can comprise two or more outlets. In such exemplary and unlimiting embodiments, the generated hydrogen gas stream and the base solution comprising the generated hydroxide base can be removed from separate outlets. In some embodiments, the acid solution from the second compartment can be delivered to the acid leaching (i) system for use therein. In other embodiments, the acid solution from the second compartment can be sold as a commodity chemical. In some embodiments, the base hydroxide from the first compartment can be delivered to the carbon capture system (v) for use therein. In other embodiments, the base hydroxide from the first compartment can be sold as a commodity chemical.

In still further embodiments, the electro-synthesizer system can be constructed by any known in the art methods. For example, and without limitations, each compartment can be any vessel configured to receive and retain disclosed above streams. In yet other embodiments, the electro-synthesizer system can comprise a plurality of plates positioned such that the disclosed above compartments are formed. For example and without limitations, each of the first, second and third compartments is defined by two or more plates. It is understood that all materials that are used to form the electro-synthesizer system are chemically and physically compatible with the electrolytes used in the system as well as output streams formed in the system compartments.

In still further embodiments, each of the compartments can have any width that can accommodate the desired flow rate of the described above streams. In some embodiments, the first compartment can have a width of about 0.01 mm to about 500 mm. For example, and without limitations, the width of the first compartment can be about 0.01 mm to about 50 mm, about 1 mm to about 10 mm, or about 5 mm to about 100 mm, and so on.

In embodiments where the second compartment has the first and second channels, each channel can have any desired width that suits the streams' preferred flow rates. For example and without limitations, the first channel present in the second compartment has a width of about 0.01 to about 500 mm. For example, and without limitations, the width of the first channel can be about 0.01 mm to about 50 mm, or about 1 mm to about 10 mm, or about 5 mm to about 100 mm, and so on. In further embodiments, the second channel present in the second compartment has a width of about 0.01 to about 500 mm. For example, and without limitations, the width of the second channel can be about 0.01 mm to about 50 mm, or about 1 mm to about 10 mm, or about 5 mm to about 100 mm, and so on.

In still further embodiments, the third compartment can have a width of about 0.01 to about 500 mm. For example, and without limitations, the width of the third compartment can be about 0.01 mm to about 50 mm, or about 1 mm to about 10 mm, or about 5 mm to about 100 mm, and so on.

In still further embodiments, all compartments can have the same width, while in other embodiments, some of the compartments can have the same width, and some of them can have a different width. It is understood that the desired flow rate and coulombic efficiency of the cell can determine the width of the compartment. In yet still further embodiments, the width of the compartment can be changed in the cell by introducing (or removing) additional plates, gaskets, membranes, and the like.

In still further embodiments, each of the cathode and anode are electrically connected to a power source. In still further embodiments, the power source can provide a desired current to achieve the electrochemical reaction to produce the hydroxide ions and hydrogen gas in the first compartment and the hydrogen ions in the second compartment at desired efficiencies. In certain embodiments, the current can have a current density from about 50 mAh/cm² to about 500 mAh/cm², including exemplary values of about 75 mAh/cm², about 100 mAh/cm², about 125 mAh/cm², about 150 mAh/cm², about 175 mAh/cm², about 200 mAh/cm², about 225 mAh/cm², about 250 mAh/cm², about 275 mAh/cm², about 300 mAh/cm², about 325 mAh/cm², about 350 mAh/cm², about 375 mAh/cm², about 400 mAh/cm², about 425 mAh/cm², about 450 mAh/cm², and about 475 mAh/cm². In yet still further embodiments, the current density can have any value between any two foregoing values. In still further embodiments, the power source is configured to provide a desired voltage between the cathode and anode material. In such embodiments, the provided voltage can be from about 0.5 V to about 10 V, including exemplary values of about 1 V, about 1.5 V, about 2 V, about 2.5 V, about 3 V, about 3.5 V, about 4 V, about 4.5 V, about 5 V, about 5.5 V, about 6 V, about 6.5 V, about 7 V, about 7.5 V, about 8 V, about 8.5 V, about 9 V, and about 9.5 V. It is understood that any voltage having a value between any two foregoing values can be used to achieve the desired outcome.

In still further embodiments, any known in the art cathode and anode materials can be used in the disclosed system. For example, the cathode can comprise a Pt group metal or their alloys based electrode, a Ni- and its alloys-based electrode, a NiFe-based electrode, a NiTi-based electrode, a steel-based electrode, transition metal sulfates-based electrode, such as for example, and without limitations, molybdenum sulfide, tungsten sulfide, transition metal phosphide-based electrode, for example, and without limitations cobalt phosphide, Fe-based catalysts, carbon-based materials, or any combination thereof. In still further embodiments, any cathode materials capable of inducing an electrochemical generation of hydrogen can be used.

In still further embodiments, any anodes known in the art and suitable for the desired operation can be utilized. In certain embodiments, the anode can comprise a gas diffusion layer. Yet in further embodiments, the anode further comprises a hydrogen oxidation catalyst layer. It is understood that the gas diffusion layer assists with maintaining a stable gas-liquid interface. It is further understood that other configurations capable of maintaining a stable gas-liquid interface other than the disclosed herein gas diffusion layer can be used. For example, the stable gas-liquid interface can be formed by continuous bubbling of the gas through the second channel of the second compartment.

In certain embodiments, the gas diffusion layer comprises a carbon-based gas diffusion layer, a fluorocarbon-based gas diffusion layer, a hydrophobic material comprising a plurality of pores, or any combination thereof. It is understood that any hydrophobic material can be utilized. In certain embodiments, the layer can be made from the materials that are not inherently hydrophobic but can comprise a hydrophobic coating that provides the desired utility. In certain embodiments, the gas diffusion layer comprises a carbon-based paper, a carbon-based textile, a modified carbon-based paper, a modified carbon-based textile, micro-porous PTFE membrane, mesoporous PTFE membrane, macro-porous PTFE membrane, or a combination thereof. It is understood that the term “modified” as used herein refers to the disposed desired coatings on the surfaces or any other modification of the surfaces to introduce the desired surface properties. For example, the surface can be chemically, electrochemically, physically, and/or plasma modified to increase roughness, introduce the desired chemical moieties, and the like.

In still further embodiments, the hydrogen oxidation catalyst layer comprises one or more Pt group metal (PGM) or alloys thereof-based catalysts, PGM-free catalysts, and any combination thereof. In still further exemplary and unlimiting embodiments, the hydrogen oxidation catalyst layer comprises one or more of Pt/C, Pd and its alloys, Au and its alloys, Ru and its alloys, transition metal oxides and their alloys, transition metal carbides and nitrides, metal-organic frameworks, carbon-supported metal atoms, hydrogenase, hydrogenase mimic compounds, hydrogenase, or any combinations thereof.

In still further embodiments, to collect the current through both electrodes, current collectors are used for both anode and cathode. In some embodiments, the current collector can be presented as a bipolar plate, or a wire, or a plate, or any combination thereof. For example and without limitations, the current collector/bipolar plates can be made of graphite (plain or porous), titanium, gold or gold-coated metal plates, etc.

It is also understood that any known in the art cation exchange membranes and anion exchange membranes can be used. In such embodiments, any known and commercially available cation exchange membranes and anion exchange membranes can be used.

In certain embodiments, the polymeric cation-exchange membranes comprise —SO₃⁻, —COO⁻, —PO₃²⁻, —PO₃H⁻, or —C₆H₄O⁻ cation exchange functional groups. The polymers for the preparation of cation-exchange membranes can be perfluorinated ionomers such as NAFION (a perfluorosulfonic-based membrane), FLEMION, and NEOSEPTA-F, partially fluorinated polymers, non-fluorinated hydrocarbon polymers, non-fluorinated polymers with aromatic backbone, or acid-base blends. It will be appreciated that in some embodiments, depending on the need to restrict or allow migration of a specific cation or an anion species between the electrolytes, a cation exchange membrane that is more restrictive and thus allows migration of one species of cations while restricting the migration of another species of cations may be used as, e.g., a cation exchange membrane that allows migration of potassium ions into the cathode electrolyte while restricting migration of other cations into the cathode electrolyte, may be used. Such restrictive cation exchange membranes are commercially available and can be selected by one ordinarily skilled in the art. Some exemplary and commercially available membranes, such as Nafion® N117, CMI-7000, CMH-PP Ralex, EMION PF1-HLF8-15-X, CEM-Type I and CEM-Type II, etc., can be used.

Anion exchange membranes (AEM) are conventionally known in the art. In some embodiments, the polymeric anion-exchange membranes comprise —NH₃⁺, —NRH₂⁺, —NR₂H⁺, —NR₃⁺, or —SR₂⁻ anion exchange functional groups. The polymers for the preparation of anion-exchange membranes can be perfluorinated ionomers such as NAFION (a perfluorosulfonic-based membrane), FLEMION, and NEOSEPTA-F, partially fluorinated polymers, non-fluorinated hydrocarbon polymers, non-fluorinated polymers with aromatic backbone, or acid-base blends. It will be appreciated that in some embodiments, depending on the need to restrict or allow migration of a specific cation or an anion species between the electrolytes, an anion exchange membrane that is more restrictive and thus allows migration of one species of anions while restricting the migration of another species of anions may be used as, e.g., an anion exchange membrane that allows migration of chloride ions into the anode electrolyte while restricting migration of other anions into the anode electrolyte, may be used. Such restrictive anion exchange membranes are commercially available and can be selected by one ordinarily skilled in the art. In still further embodiments, any known and commercially available anion exchange membranes can be used. For example, and without limitations, Sustainion® 37-50, Nafion® 115, PiperION TP-85, Fumasep FAPQ-375, PBI, Neosepta ACN, etc. In certain embodiments, the system can comprise one or more of cation exchange membranes and/or anion exchange membranes. In still further embodiments, the cation and anion exchange membranes can be unsupported. While in other embodiments, the cation and anion exchange membranes can be supported or reinforced. For example, the cation and/or anion exchange membranes can be polymer reinforced. In such embodiments, the polymers that are used for reinforcement are inert to the first, second, and/or third electrolyte solutions present in the disclosed systems. In still further embodiments, the cation and/or anion exchange membranes can be PTFE-reinforced, PEEK reinforced, or any combination thereof.

In still further embodiments, the cation and anion exchange membranes can have any desired thickness. In some embodiments, the thickness of the membranes can be about 15 μm to about 450 μm, including exemplary values of about 20 μm, about 30 μm, about 40 μm, about 50 μm, about 60 μm, about 70 μm, about 80 μm, about 90 μm, about 100 μm, about 150 μm, about 200 μm, about 250 μm, about 300 μm, about 350 μm, and about 400 μm.

In still further embodiments, the flow of the first electrolyte, the second electrolyte, and/or the third electrolyte can be the same or different and can be determined based on the specific application. In certain embodiments, the first electrolyte, the second electrolyte, and/or the third electrolyte can have a flow rate from about 1 to about 5,000,000 mL/h, including exemplary values of about 50 mL/h, about 100 mL/h, about 200 mL/h, about 300 mL/h, about 400 mL/h, about 500 mL/h, about 600 mL/h, about 700 mL/h, about 800 mL/h, about 900 mL/h, about 1,000 mL/h, about 5,000 mL/h, about 10,000 mL/h, about 50,000 mL/h, about 100,000 mL/h, about 250,000 mL/h, about 500,000 mL/h, about 750,000 mL/h, about 1,000,000 mL/h, about 2,000,000 mL/h, about 3,000,000 mL/h, and about 4,000,000 mL/h. It is also understood that the flow rate can have any value between any two foregoing values.

In still further embodiments, the electro-synthesizer system is a recirculated-in-a-loop system. In still further embodiments, the electro-synthesizer system can be connected to one or more pumps. It is understood that in some embodiments, the desired flow of the electrolytes and other streams can be provided by any means known in the art. In some embodiments, one or more pumps are used to deliver the desired stream. While in other embodiments, pumps are not used. It is understood that any known in the art pumps can be utilized.

In still further embodiments, if desired the disclosed herein one or more electro-synthesizer systems can be driven by different cathodic and anodic reactions including but not limited to hydrogen oxidation reaction (HOR), hydrogen evolution reaction (HER), oxygen evolution reaction (OER), oxygen reduction reaction (ORR).

In still further embodiments, the disclosed herein electro-synthesizer system can be in communication with a controller. The controller can comprise a processor that allows control of the desired process. In some embodiments, the controller is a feedback loop base controller designed to adjust processing conditions based on an output. In still further embodiments, the power source used to operate the disclosed herein electro-synthesizer system can be a conventional grid power source, a renewable power source or any combination thereof. In still further embodiments, the electro-synthesizer system can be designed to work during the off-peak time to allow energy savings.

In still further embodiments, the electro-synthesizer system disclosed herein has a coulombic efficiency of greater than about 80%, about 85%, about 90%, about 95%, and 100%. In still other embodiments, the electro-synthesizer system disclosed herein exhibits a coulombic efficiency of substantially 100%.

Also disclosed herein are EHSI systems comprising one or more of the electro-synthesizer systems disclosed herein. In some embodiments, the EHSI system can comprise from 1 to about 1000, including exemplary values of 2, 3, 5, 10, 15, 20, 30, 50, 100, 250, 500, and 750 of electro-synthesizer systems. It is understood that there is actually no limit to the number of electro-synthesizer systems present in the EHSI system.

As introduced herein, the EHSI system can comprise a direct air capture (DAC) system comprising at least one acid-base electro-synthesizer (iv), at least one carbon capture system (v), and at least one carbonation system (vi). Once generated, the base hydroxide from the at least one acid-base electro-synthesizer can be used in the at least one carbon capture system to remove CO₂ from a gas source. Further, the salt solution generated in the carbonation system (vi) is used as a feed stock for the at least one acid-base electro-synthesizer.

In an exemplary and unlimiting aspect, the system for carbon capture comprises the system described in co-pending International Patent Application PCT/US2023/071105, filed on Jul. 27, 2023, in the name of Chao Wang et al. and entitled “Electrolyzers and Use of the Same for Carbon Dioxide Capture and Mining,” which are hereby incorporated by reference herein in their entirety.

As described in co-pending International Patent Application PCT/US2023/071105, a system comprising one or more flow electro-synthesizer systems as disclosed above, wherein each system is configured to produce an acid solution and a hydroxide base solution can be in fluid communication with one or more carbon dioxide capturing apparatuses that are configured to capture a carbon dioxide from a gas source by converting carbon dioxide to a carbonate-containing solution (e.g., comprising bicarbonate solution, carbonate solution, or a combination thereof).

In some embodiments, at least a portion of the hydroxide base solution formed in the first compartment is withdrawn from the system (iv) and is fed by a line to the one or more carbon dioxide-capturing apparatuses (v). It is understood that any known in the art capturing apparatuses can be used. For example and without limitations, any commercial carbon dioxide contactors can be utilized. In some exemplary and unlimiting embodiments, the carbon dioxide contactor comprises the system described in co-pending International Patent Application No. PCT/US2023/071488, filed on Aug. 2, 2023, in the name of Chao Wang and Yulin LIU and entitled “Efficient Liquid-Air Contactor in Parallel Flow Configuration,” which is hereby incorporated by reference herein in its entirety. Briefly, the at least one air contactor disclosed in the PCT/US2023/071488 application comprises an air contactor membrane module that comprises a housing and a plurality of membranes within said housing. The plurality of membranes comprising modified polypropylene creates a barrier separating a gas phase from a liquid phase. The polypropylene material of the membranes comprises pores such that specific molecules in the gas phase can diffuse through the membrane and into the liquid phase to react with the liquid phase. The surface of the membranes is designed to be substantially hydrophobic, effectively preventing water molecules from entering the gas phase. However, this specific contactor is exemplary, and any other known contactor can be used for the desired purpose.

Within the carbon dioxide contactor, the captured carbon dioxide reacts with the hydroxide base solution (e.g., from the at least one electro-synthesizer) to form a carbonate-containing solution. In still further embodiments, the one or more carbon dioxide capturing apparatuses captures CO₂ and generates a gas that comprises less than about 200 ppm of carbon dioxide, less than about 100 ppm of carbon dioxide, less than about 50 ppm of carbon dioxide, or less than about 10 ppm of carbon dioxide. In yet still further embodiments, the generated gas is substantially free of carbon dioxide.

It is understood that carbon dioxide can be captured from any gas. For example, and without limitations, the gas, directed towards one or more carbon dioxide-capturing apparatuses, can comprise ambient air, industrial gas source, substantially high concentration carbon dioxide, or any combination thereof. In still further embodiments, the gas source is the ambient air. In other embodiments, the gas source is the industrial gas source. In still further embodiments, the gas source is a substantially high concentration of carbon dioxide. It is understood that the ambient air includes indoor and outdoor air. In still further embodiments, it is understood that industrial gas sources include any waste gas stream, any gas stream that is a by-product of any manufacturing processes, or a by-product of any industrial processes. In some embodiments, the gas source is obtained from various industrial sources that release carbon dioxide, including carbon dioxide from combustion gases of fossil-fueled power plants, e.g., conventional coal, oil and gas power plants, or IGCC (Integrated Gasification Combined Cycle) power plants that generate power by burning syngas; cement manufacturing plants that convert limestone to lime; ore processing plants; fermentation plants; and the like. In some embodiments, the gas source may comprise other gases, e.g., nitrogen, oxides of nitrogen (nitrous oxide, nitric oxide), sulfur and sulfur gases (sulfur dioxide, hydrogen sulfide), and vaporized materials. In some embodiments, the gas source is scrubbed or otherwise treated to remove at least a portion of gases other than carbon dioxide prior to flowing into the carbon dioxide-capturing apparatus. Yet, in other embodiments, the gas source is untreated prior to being flown into the carbon dioxide-capturing apparatus.

In some embodiments, a source for the hydroxide base for the carbon capture system solution can be the acid-base electro-synthesizer system (iv), via a connection such as that shown in FIG. 1. It should be appreciated by the person skilled in the art that a source of all, or a portion, of the hydroxide base for the carbon capture system can be from an external source instead.

In still further embodiments, the EHSI system can further comprise one or more carbonation devices (vi). As can be seen in FIG. 1, the one or more carbonation devices are in fluid communication with the one or more electrowinning systems (iii), the one or more carbon capture systems (v) and the one or more acid-base electro-synthesizer systems (iv). In still further embodiments, at least the third compartment of the one or more electro-synthesizer systems is in fluid communication with the one or more carbonation devices.

In some embodiments, at least a portion of the iron-free solution from the electrowinning device (iii) and at least a portion of the carbonate-containing solution from the carbon capture device (v) is introduced to the carbonation system for reaction therein. Within the carbonation system, carbon in the carbonate-containing solution is sequestrated as solid (Mg, Ca)CO₃ and a salt solution (e.g., Na₂SO₄) is generated and fed back to the third compartment of the acid-base electro-synthesizer system (iv) to close the mass balance. In still further embodiments, it is understood that at least a portion of the third electrolyte solution comprises the salt solution formed in the one or more carbonation systems, and wherein the salt solution is the same or different from one or more inorganic salts present in the third electrolyte. The flow rate of each stream can have any value of the disclosed above flow rates.

It is understood that all materials that are used to form the carbonation system are chemically and physically compatible with the iron-free solution (from electrowinning) and the carbonate-containing solution (from carbon capture) used in the system as well as output streams formed in the system. In still further embodiments, if desired, the one or more carbonation devices can comprise mixing means.

In still further embodiments, it is understood that the one or more electro-synthesizer systems (iv) generate the acid solution and the hydroxide base solution in a batch or a continuous operation. In yet still further embodiments, the one or more electro-synthesizer systems generate the acid solution and the hydroxide base solution utilizing an energy source configured to operate continuously or on demand. For example, in some embodiments, the electro-synthesizer systems can utilize off-peak periods when the energy is cheap. In such exemplary and unlimiting embodiments, the flow electro-synthesizer systems can be stopped when energy is expensive and operate only when energy is cheap. In certain embodiments, the generated acids/bases can be utilized immediately. While in other embodiments, the generated acids/bases can be collected for further desired applications. In yet still further embodiments, other parts of the system, for example, the carbon capturing systems (v) and/or the one or more carbonation system (vi), operate continuously without interruptions.

The system can be controlled by any controllers, as disclosed above.

It is understood that any of the disclosed above electro-synthesizer systems can be used in the EHSI system. In some embodiments, at least a portion of the base hydroxide solutions formed in the first compartment of the electro-synthesizer system is withdrawn and is delivered to the carbon capture system. The one or more carbon capture systems are configured continuously to receive carbon dioxide gas from a gas source. Any of the disclosed above gas sources can be utilized. At least a portion of the carbon-containing solution formed in the one or more carbon capture systems is then transferred to the one or more carbonation systems. In some embodiments, at least a portion of the acid solution formed in the second compartment of the electro-synthesizer system is withdrawn and flown into one or more acid leaching systems. The acid solution dissolves the iron-containing materials that are introduced to the acid leaching system to form a leachate comprising at least one of Fe³⁺, Fe²⁺, Ca²⁺, Mg²⁺, and/or Al³⁺ that are then transferred to the one or more comproportionation/reduction systems. In the one or more comproportionation/reduction systems, the Fe³⁺ in the leachate is reduced to Fe²⁺ yielding a Fe³⁺-free leachate, which is delivered to the electrowinning system, wherein Fe, acid solution, hydrogen gas, and iron-free solution is generated. The iron-free solution from electrowinning can be introduced to the carbonation system for reaction with the carbonate-containing solutions to sequester the carbon, thereby closing the mass balance.

Advantageously, in some embodiments, once in operation, the EHSI system, and method of using same, only requires an iron-containing material feed and a gas source feed. It is appreciated by the person skilled in the art that at start-up, additional feeds (e.g., acid solution in the leaching system) are necessary in order for each of the systems to operate properly.

### Computer Program Product

The present subject matter described in the first, second or third aspect may be a system, a method, and/or a computer program product. In some embodiments, the computer program product may include a computer readable storage medium (or media) having computer readable program instructions thereon for causing a processor to carry out aspects of the present subject matter.

In some embodiments, the computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In some embodiments, computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

In some embodiments, the computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In some embodiments, the computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In some embodiments, the computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In light of the present disclosure and the general level of skill in the art, those of skill can appreciate that the following examples are intended to be exemplary only and that numerous changes, modifications, and alterations can be employed without departing from the scope of the presently disclosed subject matter. The synthetic descriptions and specific examples that follow are only intended for the purposes of illustration, and are not to be construed as limiting in any manner to make compounds of the disclosure by other methods.

### Clauses

Clause 1: An electrochemical hydrometallurgical for sustainable ironmaking (EHSI) system comprising:
   one or more flow electro-synthesizer systems configured to produce an acid solution and a hydroxide base solution;
   one or more carbon dioxide capturing systems that is in fluid communication with the one or more flow electro-synthesizer systems and that are configured to capture a carbon dioxide from a gas source by converting the carbon dioxide to a carbonate-containing solution;
   one or more acid leaching systems that are optionally in fluid communication with the one or more flow electro-synthesizer systems and that are configured to receive an iron-containing material comprising iron and produce a leachate comprising at least one of Fe³⁺ and Fe²⁺;
   one or more comproportionation systems that are in fluid communication with the one or more acid leaching systems and that are configured to reduce Fe³⁺ in the leachate to Fe²⁺ and produce a Fe³⁺-free leachate;
   one or more electrowinning systems that is in fluid communication with the one or more comproportionation systems and that are configured to convert the Fe²⁺ in the Fe³⁺-free leachate to Fe⁰; and
   one or more carbonation systems that are in fluid communication with the one or more electrowinning systems and with the one or more carbon dioxide capturing systems and that are configured to sequester carbon from the carbonate-containing solution.
Clause 2: The EHSI system of clause 1, wherein the one or more flow electro-synthesizer systems comprise:
   a first compartment comprising:
      a cathode;
      a first electrolyte solution that is in electrical and fluid communication with the cathode; wherein a pH of the first electrolyte solution is 6≤pH≤15.5;
      wherein the cathode is configured to generate a hydrogen gas and the hydroxide base solution;
   a second compartment comprising:
      an anode; and a second electrolyte solution that is in electrical and fluid communication with the anode; wherein a pH of the second electrolyte solution is −1.5≤pH≤8;
      wherein the anode is configured to generate the acid solution; and a third compartment positioned between and in fluid communication with the first compartment and the second compartment and comprising:
      a third electrolyte solution, wherein a pH of the third electrolyte solution is 4≤pH≤10.
Clause 3: The EHSI system of clause 2, wherein the third electrolyte solution comprises one or more inorganic salts.
Clause 4: The EHSI system of any one of clauses 1-3, wherein the hydroxide base comprises one or more of sodium hydroxide, lithium hydroxide, potassium hydroxide, magnesium hydroxide, calcium hydroxide, ammonium hydroxide, or any combination thereof, preferably sodium hydroxide.
Clause 5: The EHSI system of any one of clauses 1-4, wherein the acid solution comprises one or more of hydrochloric acid, hydrobromic acid, hydroiodic acid, sulfurous acid, sulfuric acid, nitric acid, phosphorous acid, phosphoric acid, hypochlorous acid, chlorous acid, chloric acid, perchloric acid, formic acid, acetic acid, carbonic acid, or any combination thereof, preferably sulfuric acid.
Clause 6: The EHSI system of any one of clauses 3-5, wherein the one or more inorganic salts comprise sodium chloride, potassium chloride, lithium chloride, sodium bromide, potassium bromide, lithium bromide, sodium iodide, potassium iodide, lithium iodide, sodium sulfite, potassium sulfite, lithium sulfite, sodium sulfate, potassium sulfate, lithium sulfate, sodium nitrate, potassium nitrate, lithium nitrate, sodium nitrite, potassium nitrite, lithium nitrite, sodium phosphite, potassium phosphite, lithium phosphite sodium phosphate, potassium phosphate, lithium phosphate, sodium hypochlorite, potassium hypochlorite, lithium hypochlorite, sodium chlorite, potassium chlorite, lithium chlorite, sodium chlorate, potassium chlorate, lithium chlorate, sodium perchlorate, potassium perchlorate, and lithium perchlorate, or any combination thereof, preferably sodium sulfate.
Clause 7: The EHSI system of any one of clauses 2-6, wherein the second compartment is configured to receive a hydrogen stream to be oxidized on the anode to produce the acid solution, wherein the hydrogen stream comprises the hydrogen gas formed in the first compartment, a hydrogen provided from an external source, or a combination thereof.
Clause 8: The EHSI system of any one of clauses 2-7, wherein the third compartment is separated from the first compartment with one or more cation exchange membranes and is separated from the second compartment with one or more anion exchange membranes.
Clause 9: The EHSI system of any one of clauses 2-8, wherein the one or more flow electro-synthesizer systems operate at a voltage of about 1.0 V to about 10.0 V.
Clause 10: The EHSI system of any one of clauses 2-9, wherein the one or more flow electro-synthesizer systems generate the acid solution and the hydroxide base solution in a batch or in a continuous operation.
Clause 11: The EHSI system of any one of clauses 1-10, wherein at least a portion of the hydroxide base solution formed in the first compartment is fed to the one or more carbon dioxide capturing systems configured to capture the carbon dioxide such that the carbon dioxide is converted to the carbonate-containing solution thereof by reacting the carbon dioxide from the gas source with the at least a portion of the hydroxide base solution.
Clause 12: The EHSI system of clause 11, wherein the carbonate-containing solution comprises at least one of bicarbonate, carbonate, or a combination thereof.
Clause 13: The EHSI system of any one of clauses 1-12, wherein one or more carbon dioxide capturing apparatuses comprise an air contactor.
Clause 14: The EHSI system of any one of clauses 1-13, wherein the one or more carbon dioxide capturing apparatuses captures carbon dioxide such that a gas comprising less than about 200 ppm of carbon dioxide is generated.
Clause 15: The EHSI system of clause 14, wherein the generated gas is substantially free of carbon dioxide.
Clause 16: The EHSI system of any one of clauses 1-15, wherein the gas source is an ambient air, industrial gas source, or any combination thereof.
Clause 17: The EHSI system of clause 16, wherein the gas is the ambient air.
Clause 18: The EHSI system of any one of clauses 1-17, wherein at least a portion of the acid solution formed in the second compartment of the one or more electro-synthesizer systems is fed to one or more acid leaching systems.
Clause 19: The EHSI system of any of clauses 1-18, wherein the leachate further comprises at least one of Ca²⁺, Mg²⁺, and Al³⁺.
Clause 20: The EHSI system of any of clauses 1-19, wherein the iron-containing material comprises at least one of imported iron ore fines, taconite, slag, tailing, gangue, and mixtures thereof.
Clause 21: The EHSI system of any of clauses 1-20, wherein the one or more comproportionation systems further comprise delivery of at least one reducing agent thereto to convert Fe³⁺ to Fe²⁺ therein.
Clause 22: The EHSI system of clause 21, wherein the reducing agent comprises hydrogen gas and the one or more comproportionation systems is in gaseous communication with the one or more electrowinning systems to receive at least a portion of the hydrogen gas produced in the one or more electrowinning systems.
Clause 23: The EHSI system of clause 21, wherein the reducing agent comprises Fe⁰ and the one or more comproportionation systems is connected to the one or more electrowinning systems such that at least a portion of the Fe⁰ from the one or more electrowinning systems can be delivered to the one or more comproportionation systems.
Clause 24: The EHSI system of any of clauses 1-23, wherein the one or more electrowinning systems comprise an AEM electrolyzer.
Clause 25: The EHSI system of clause 24, wherein the AEM electrolyzer comprises two compartments separated by an anion exchange membrane, wherein Fe²⁺ in the Fe³⁺-free solution is reduced to Fe⁰ at an AEM cathode in a first AEM compartment, simultaneously producing an iron-free solution, and wherein acid solution is produced at an AEM anode in the second AEM compartment.
Clause 26: The EHSI system of clause 25, wherein the one or more electrowinning systems is in fluid communication with the one or more acid leaching systems to deliver the acid solution thereto.
Clause 27: The EHSI system of any of clauses 1-26, wherein an iron-free solution from the one or more electrowinning systems reacts with the carbonate-containing solution from the one or more carbon dioxide capturing systems in the one or more carbonation systems to produce a carbonate-containing solid and a salt solution.
Clause 28: The EHSI system of any of clauses 1-27, wherein the one or more carbonation systems is in fluid communication with the one or more flow electro-synthesizer systems.
Clause 29: The EHSI system of clause 28, wherein the salt solution from the one or more carbonation systems is delivered to the third compartment of the one or more flow electro-synthesizer systems.
Clause 30: The EHSI system of any of clauses 1-29, wherein the Fe⁰ from the one or more electrowinning systems is collected for further processing.
Clause 31: The EHSI system of any of clauses 1-30, wherein at least one acid leaching system comprises multiple containers, wherein the concentration of acid in the multiple containers is different from one another.
Clause 32: A method of producing iron from an iron-containing material comprising providing one or more of the EHSI systems of any of clauses 1-30;
   electrochemically generating a hydrogen gas and a hydroxide base on the cathode in the first compartment; and
   flowing a stream comprising a generated hydrogen gas, a hydrogen gas provided by an external source, or a combination thereof, such that electrochemically generated hydrogen ions are formed on the anode to produce an acid solution;
   directing at least a portion of the first electrolyte comprising the hydroxide base to one or more carbon dioxide capturing systems configured to capture a carbon dioxide from a gas source by converting the carbon dioxide to a carbonate-containing solution;
   optionally directing at least a portion of the second electrolyte comprising acid solution to one or more acid leaching systems, wherein the one or more acid leaching systems comprise an iron-containing material, and a leachate comprising at least one of Fe³⁺ and Fe²⁺ is produced;
   directing the leachate to the one or more comproportionation systems to reduce Fe³⁺ to Fe²⁺ to produce a Fe³⁺-free leachate;
   directing the Fe³⁺-free leachate to the one or more electrowinning systems to produce Fe⁰, an acid solution, and iron-free solution;
   optionally directing at least a portion of the acid solution from the one or more electrowinning systems to one or more acid leaching systems;
   directing the carbonate-containing solution and the iron-free solution to the one or more carbonation systems to sequester the carbon from the carbonate-containing solution as a carbonate-containing solid, while generating a salt solution; and
   directing the salt solution to the third compartment in the one or more flow electro-synthesizers to close the mass balance.
Clause 33: The method of clause 32, wherein at least a portion of the second electrolyte comprising acid solution is directed to one or more acid leaching systems.
Clause 34: The method of clauses 32 or 33, wherein at least a portion of the acid solution from the one or more electrowinning systems is directed to one or more acid leaching systems.

What is claimed is:

1. An electrochemical hydrometallurgical for sustainable ironmaking (EHSI) system comprising:
one or more flow electro-synthesizer systems configured to produce an acid solution and a hydroxide base solution;
one or more carbon dioxide capturing systems that is in fluid communication with the one or more flow electro-synthesizer systems and that are configured to capture a carbon dioxide from a gas source by converting the carbon dioxide to a carbonate-containing solution;
one or more acid leaching systems that are optionally in fluid communication with the one or more flow electro-synthesizer systems and that are configured to receive an iron-containing material comprising iron and produce a leachate comprising at least one of Fe³⁺ and Fe²⁺;
one or more comproportionation systems that are in fluid communication with the one or more acid leaching systems and that are configured to reduce Fe³⁺ in the leachate to Fe²⁺ and produce a Fe³⁺-free leachate;
one or more electrowinning systems that is in fluid communication with the one or more comproportionation systems and that are configured to convert the Fe²⁺ in the Fe³⁺-free leachate to Fe⁰; and
one or more carbonation systems that are in fluid communication with the one or more electrowinning systems and with the one or more carbon dioxide capturing systems and that are configured to sequester carbon from the carbonate-containing solution.

2. The EHSI system of claim 1, wherein the one or more flow electro-synthesizer systems comprise:
a first compartment comprising:
a cathode;
a first electrolyte solution that is in electrical and fluid communication with the cathode; wherein a pH of the first electrolyte solution is 6≤pH≤15.5;
wherein the cathode is configured to generate a hydrogen gas and the hydroxide base solution;
a second compartment comprising:
an anode; and
a second electrolyte solution that is in electrical and fluid communication with the anode; wherein a pH of the second electrolyte solution is −1.5≤pH≤8;
wherein the anode is configured to generate the acid solution; and
a third compartment positioned between and in fluid communication with the first compartment and the second compartment and comprising:
a third electrolyte solution, wherein a pH of the third electrolyte solution is 4≤pH≤10.

3. The EHSI system of claim 2, wherein the third electrolyte solution comprises one or more inorganic salts.

4. The EHSI system of claim 1, wherein the hydroxide base comprises one or more of sodium hydroxide, lithium hydroxide, potassium hydroxide, magnesium hydroxide, calcium hydroxide, ammonium hydroxide, or any combination thereof, preferably sodium hydroxide.

5. The EHSI system of claim 1, wherein the acid solution comprises one or more of hydrochloric acid, hydrobromic acid, hydroiodic acid, sulfurous acid, sulfuric acid, nitric acid, phosphorous acid, phosphoric acid, hypochlorous acid, chlorous acid, chloric acid, perchloric acid, formic acid, acetic acid, carbonic acid, or any combination thereof, preferably sulfuric acid.

6. The EHSI system of claim 1, wherein the one or more inorganic salts comprise sodium chloride, potassium chloride, lithium chloride, sodium bromide, potassium bromide, lithium bromide, sodium iodide, potassium iodide, lithium iodide, sodium sulfite, potassium sulfite, lithium sulfite, sodium sulfate, potassium sulfate, lithium sulfate, sodium nitrate, potassium nitrate, lithium nitrate, sodium nitrite, potassium nitrite, lithium nitrite, sodium phosphite, potassium phosphite, lithium phosphite sodium phosphate, potassium phosphate, lithium phosphate, sodium hypochlorite, potassium hypochlorite, lithium hypochlorite, sodium chlorite, potassium chlorite, lithium chlorite, sodium chlorate, potassium chlorate, lithium chlorate, sodium perchlorate, potassium perchlorate, and lithium perchlorate, or any combination thereof, preferably sodium sulfate.

7. The EHSI system of claim 2, wherein the second compartment is configured to receive a hydrogen stream to be oxidized on the anode to produce the acid solution, wherein the hydrogen stream comprises the hydrogen gas formed in the first compartment, a hydrogen provided from an external source, or a combination thereof.

8. The EHSI system of claim 1, wherein at least a portion of the hydroxide base solution formed in the first compartment is fed to the one or more carbon dioxide capturing systems configured to capture the carbon dioxide such that the carbon dioxide is converted to the carbonate-containing solution thereof by reacting the carbon dioxide from the gas source with the at least a portion of the hydroxide base solution.

9. The EHSI system of claim 1, wherein one or more carbon dioxide capturing apparatuses comprise an air contactor.

10. The EHSI system of claim 1, wherein the one or more carbon dioxide capturing apparatuses captures carbon dioxide such that a gas comprising less than about 200 ppm of carbon dioxide is generated.

11. The EHSI system of claim 1, wherein at least a portion of the acid solution formed in the second compartment of the one or more electro-synthesizer systems is fed to one or more acid leaching systems.

12. The EHSI system of claim 1, wherein the leachate further comprises at least one of Ca²⁺, Mg²⁺, and Al³⁺.

13. The EHSI system of claim 1, wherein the one or more comproportionation systems further comprise delivery of at least one reducing agent thereto to convert Fe³⁺ to Fe²⁺ therein.

14. The EHSI system of claim 13, wherein (a) the reducing agent comprises hydrogen gas and the one or more comproportionation systems is in gaseous communication with the one or more electrowinning systems to receive at least a portion of the hydrogen gas produced in the one or more electrowinning systems, or (b) the reducing agent comprises Fe⁰ and the one or more comproportionation systems is connected to the one or more electrowinning systems such that at least a portion of the Fe⁰ from the one or more electrowinning systems can be delivered to the one or more comproportionation systems.

15. The EHSI system of claim 1, wherein the one or more electrowinning systems comprise an AEM electrolyzer.

16. The EHSI system of claim 15 wherein the AEM electrolyzer comprises two compartments separated by an anion exchange membrane, wherein Fe²⁺ in the Fe³⁺-free solution is reduced to Fe⁰ at an AEM cathode in a first AEM compartment, simultaneously producing an iron-free solution, and wherein acid solution is produced at an AEM anode in the second AEM compartment.

17. The EHSI system of claim 16, wherein the one or more electrowinning systems is in fluid communication with the one or more acid leaching systems to deliver the acid solution thereto.

18. The EHSI system of claim 1, wherein the one or more carbonation systems is in fluid communication with the one or more flow electro-synthesizer systems.

19. The EHSI system of claim 18, wherein the salt solution from the one or more carbonation systems is delivered to the third compartment of the one or more flow electro-synthesizer systems.

20. A method of producing iron from an iron-containing material comprising
providing one or more of the EHSI systems of claim 1;
electrochemically generating a hydrogen gas and a hydroxide base on the cathode in the first compartment; and
flowing a stream comprising a generated hydrogen gas, a hydrogen gas provided by an external source, or a combination thereof, such that electrochemically generated hydrogen ions are formed on the anode to produce an acid solution;
directing at least a portion of the first electrolyte comprising the hydroxide base to one or more carbon dioxide capturing systems configured to capture a carbon dioxide from a gas source by converting the carbon dioxide to a carbonate-containing solution;
optionally directing at least a portion of the second electrolyte comprising acid solution to one or more acid leaching systems, wherein the one or more acid leaching systems comprise an iron-containing material, and a leachate comprising at least one of Fe³⁺ and Fe²⁺ is produced;
directing the leachate to the one or more comproportionation systems to reduce Fe³⁺ to Fe²⁺ to produce a Fe³⁺-free leachate;
directing the Fe³⁺-free leachate to the one or more electrowinning systems to produce Fe⁰, an acid solution, and iron-free solution;
optionally directing at least a portion of the acid solution from the one or more electrowinning systems to one or more acid leaching systems;
directing the carbonate-containing solution and the iron-free solution to the one or more carbonation systems to sequester the carbon from the carbonate-containing solution as a carbonate-containing solid, while generating a salt solution; and
directing the salt solution to the third compartment in the one or more flow electro-synthesizers to close the mass balance.
